(19) United States
(12) Patent Application Publication
(10) Pub. No.: US 2008/0028122 A1
(43) Pub. Date: Jan. 31, 2008

(54) IEEE 1394 AV network system and method of forming a network thereof

(75) Inventor: Yong-jun Park, Seoul (KR)

Correspondence Address: STANZIONE & KIM, LLP, 919 18TH STREET, N.W., SUITE 440, WASHINGTON, DC, 20006, US

(73) Assignee: Samsung Electronic Co., Ltd., Suwon-si (KR)

(21) Appl. No.: 11/648,624

(22) Filed: Jan. 3, 2007

(30) Foreign Application Priority Data
Jul. 31, 2006 (KR) 2006-72253

(51) Int. Cl. G06F 13/00

(52) U.S. Cl. 710/316

(57) ABSTRACT

An IEEE 1394 audio/video (AV) network system having a switching structure and a method of forming a network thereof. A method of forming a network in a network system using a digital interface includes checking a power on/off state of a digital interface device in the network, and if the power off state is sensed, transmitting a bus reset command to digital interface devices that form the network and bypassing a connected digital interface bus signal to another digital interface device.

### CROSS-REFERENCE TO RELATED APPLICATIONS

This application claims priority under 35 U.S.C. 119 §(a) from Korean Patent Application No. 10-2006-0072253, filed on Jul. 31, 2006, in the Korean Intellectual Property Office, the disclosure of which is incorporated herein in its entirety by reference.

### BACKGROUND OF THE INVENTION

1. Field of the Invention

The present general inventive concept relates to a digital interface network system such as Institute of Electrical and Electronic Engineers (IEEE) 1394, and more particularly, to an IEEE 1394 audio/video (AV) network system having a switching structure and a method of forming a network thereof.

2. Description of the Related Art

A conventional digital interface can be used to connect an audio/video (AV) receiver device, a Digital Versatile Disc (DVD) player, a television (TV), and a Compact Disc (CD) player to each other. Typically, devices using a digital interface communicate according to a specific bus protocol. A representative digital interface is the Institute of Electrical and Electronic Engineers (IEEE) 1394.

An AV receiver device and electronic devices, such as a DVD player, TV, and a CD player, are connected to each other using an IEEE 1394 serial bus to transmit and receive audio and control signals in a packet basis. Thus, the AV receiver device can check and control information on a network to which the AV receiver device belongs by displaying information regarding devices connected thereto using the IEEE 1394 serial bus.

The IEEE 1394 serial bus can connect a maximum of 63 devices to each other in a daisy chain or tree pattern as illustrated in FIGS. 1 and 2, respectively.

However as illustrated in FIG. 3, if a user turns off an intermediately connected IEEE 1394 device 310 in an IEEE 1394 network, IEEE 1394 devices 320 in a lower layer are disconnected. Thus, the IEEE 1394 devices 320 in the lower layer of the IEEE 1394 device 310 in a power off state cannot be controlled, and thus, an IEEE 1394 architecture, which is executed by a user, is suddenly and inconveniently changed.

### SUMMARY OF THE INVENTION

The present general inventive concept provides an Institute of Electrical and Electronic Engineers (IEEE) 1394 audio/video (AV) network system in which an IEEE 1394 interface architecture is maintained regardless of a power on/off state or an operational error of an intermediately connected device in an IEEE 1394 network, and a method of forming the IEEE 1394 network thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a method of forming a network in a network system using a digital interface, the method including checking a power on/off state of a digital interface device in the network, and if the power off state is sensed, transmitting a bus reset command to digital interface devices that form the network and bypassing a connected digital interface bus signal to another digital interface device.

The foregoing and/or other aspects and utilities of the present general inventive concept may also be achieved by providing an IEEE 1394 AV network system including an IEEE 1394 controller to accept an IEEE 1394 bus signal connected to IEEE 1394 devices or to bypass the IEEE 1394 bus signal to another IEEE 1394 device according to a power on/off state, and to control connection with the IEEE 1394 devices, and a data processing unit to transmit a bus reset command to the IEEE 1394 controller by sensing the power on/off state of a system, to simultaneously switch a bypass mode and an input mode of the IEEE 1394 controller, and to decode a signal input from the IEEE 1394 controller.

The foregoing and/or other aspects and utilities of the present general inventive concept may also be achieved by providing a digital interface device with a digital signal processor (DSP), including a CPU to sense a power off state of the digital interface device and to output a switch off command, another CPU to communicate with the DSP and form a network between the digital interface device and another digital interface device in the power on state, and to receive the output switch off command and generate a switching control signal in the power off state, and a switcher to connect signal lines to the DSP in the power on state, and to receive the switching control signal from the another CPU in the power off state, and redirect the signal lines from the DSP to another digital interface device.

The digital interface device may further include a data processing unit to compare a current voltage with a reference voltage to determine whether the digital interface device is in a power off state or a power on state.

The data processing unit may further determine whether the digital interface device is in an error state if the digital interface device was in a power on state.

The digital interface device may further include disconnecting from the second digital interface device when in an error state, and the digital interface device connects to the second digital interface device when in a non-error state.

The foregoing and/or other aspects and utilities of the present general inventive concept may also be achieved by providing a method of controlling a digital interface device, including connecting signal lines to a digital signal processor (DSP) in a power on state, disconnecting signal lines from the DSP in a power off state and redirecting the signal lines to another digital interface device, and communicating with the DSP in the power on state to form a network between the digital interface device and the another digital interface device, wherein the digital interface device disconnects from the network in the power off state.

The method may further include comparing a current voltage with a reference voltage to determine whether the digital interface device is in a power off state or a power on state.

The method may further include determining whether the digital interface device is in an error state if the digital interface device was in a power on state.

The method may further include disconnecting the digital interface device from the another digital interface device when in an error state, and connecting the digital interface device to the another digital interface device when in a non-error state.

The foregoing and/or other aspects and utilities of the present general inventive concept may also be achieved by providing a switching system used with an IEEE 1394 AV network system, including a controller to select between a bypass mode to bypass an IEEE 1394 bus signal from one IEEE 1394 device to another IEEE 1394 or an input mode to input the IEEE bus signal to the one IEEE 1394 device, and a data processor to sense a state of an IEEE 1394 device and to simultaneously provide a bypass or input mode switching control signal to the controller, and to decode a signal received from the controller.

If the data processor senses a power off state or an abnormal state of an IEEE 1394 device, then the data processor may receive bus connection information by providing a bus reset command to the controller and receives in response a message to confirm a switch off mode by transmitting the switch off command to bypass the IEEE 1394 bus signal to another IEEE 1394 device.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a conventional Institute of Electrical and Electronic Engineers (IEEE) 1394 network configuration having a daisy chain structure;

FIG. 2 is a view illustrating a conventional IEEE 1394 network configuration having a tree structure;

FIG. 3 is a conceptual diagram illustrating a connection configuration of a conventional IEEE 1394 network when an intermediate connection device is turned off;

FIG. 4 is a block diagram illustrating an IEEE 1394 device according to an embodiment of the present general inventive concept;

FIG. 5 is a block diagram illustrating the IEEE 1394 controller illustrated in FIG. 4, according to an embodiment of the present general inventive concept;

FIG. 6 is a circuit diagram illustrating the IEEE 1394 controller illustrated in FIG. 4, which allows network connection when an IEEE 1394 network system is turned on, according to an embodiment of the present general inventive concept;

FIG. 7 is a circuit diagram illustrating the IEEE 1394 controller illustrated in FIG. 4, which does not allow network connection when the IEEE 1394 network system is turned off or abnormally operates, according to an embodiment of the present general inventive concept;

FIG. 8 is a flowchart illustrating a method of forming an IEEE 1394 audio/video (AV) network when an IEEE 1394 device is turned off, according to an embodiment of the present general inventive concept;

FIG. 9 is a flowchart illustrating a method of forming an IEEE 1394 AV network when a system is turned on, according to an embodiment of the present general inventive concept; and

FIG. 10 is a conceptual diagram illustrating a connection configuration of an IEEE 1394 network when an intermediately connected device is turned off, according to an embodiment of the present general inventive concept.

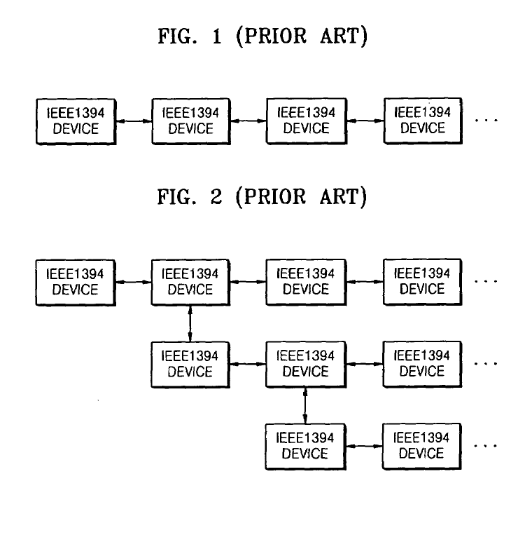

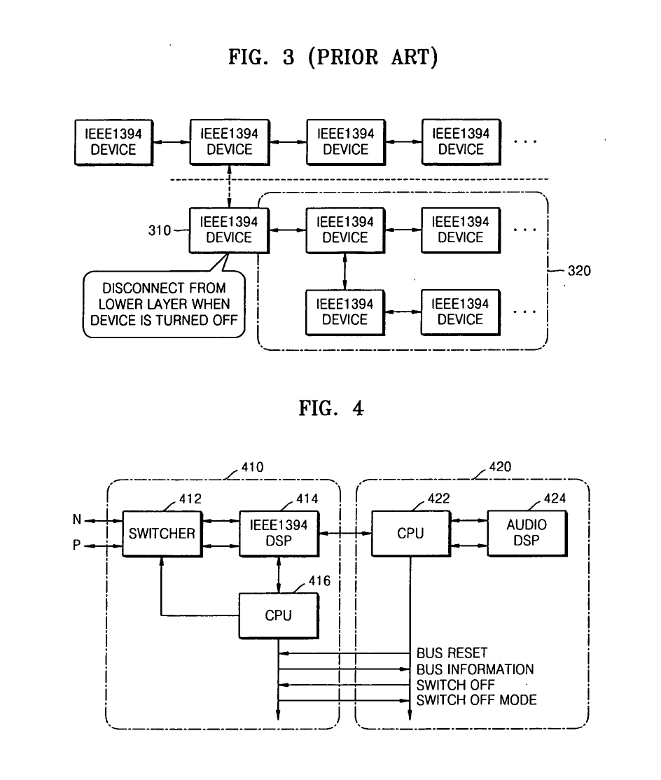

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 4 illustrates a block diagram of an Institute of Electrical and Electronic Engineers (IEEE) 1394 device according to an embodiment of the present general inventive concept.

Referring to FIG. 4, the IEEE 1394 device includes an IEEE 1394 controller 410 and a data processing unit 420, which communicate therebetween using a serial communication.

The IEEE 1394 controller 410 includes a switcher 412, an IEEE 1394 digital signal processor (DSP) 414, and a central processing unit (CPU) 416. The IEEE 1394 controller 410 selects a bypass mode in which an IEEE 1394 bus signal connected to IEEE 1394 devices is bypassed to another IEEE 1394 device or an input mode in which the IEEE 1394 bus signal is accepted, and controls connection with other IEEE 1394 devices. The data processing unit 420 includes a CPU 422 and an audio DSP 424. The data processing unit 420 transmits a bus reset command to the IEEE 1394 controller 410 by sensing a power on/off state and simultaneously provides a bypass or input mode switching control signal to the IEEE 1394 controller 410, and decodes a signal input from the IEEE 1394 controller 410.

In addition, the IEEE 1394 device has a network on/off selection menu. A user can manually disconnect from a network using the network on/off selection menu. Thus, the IEEE 1394 device can operate independently from other devices connected to the network using the network on/off selection menu, and when the IEEE 1394 device is turned on or when an abnormal operation of the IEEE 1394 device is corrected, the IEEE 1394 device can normally operate by being connected to the network.

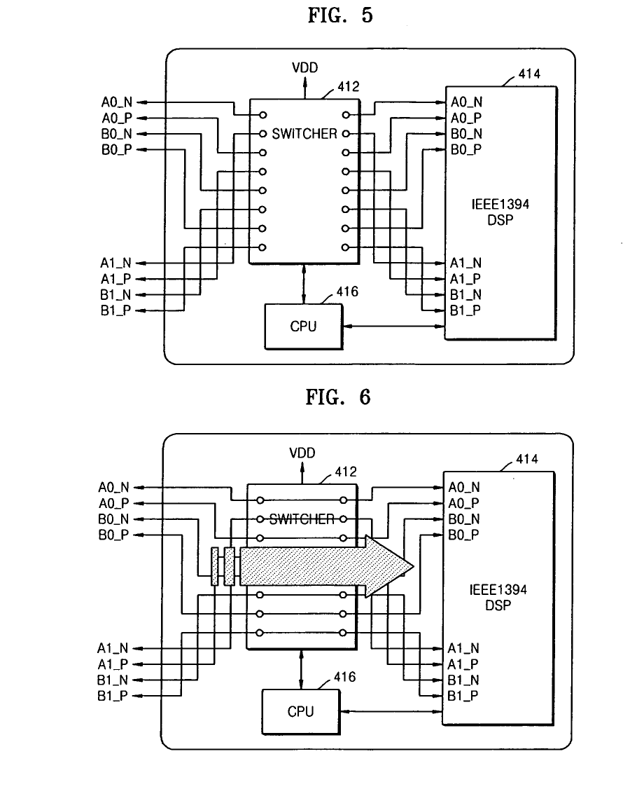

FIG. 5 is a block diagram of the IEEE 1394 controller 410 illustrated in FIG. 4, according to an embodiment of the present general inventive concept. The IEEE 1394 controller 410 of FIG. 4 will now be described in more detail with reference to FIG. 5.

Referring to FIG. 5, the switcher 412 performs signal processing by accepting the IEEE 1394 bus signal connected to the network or bypasses the IEEE 1394 bus signal to another IEEE 1394 device according to the switching control signal. The IEEE 1394 bus signal includes 4 pair type signals A0_N (A1_N), A0_P (A1_P), B0_N (B1_N), and B0_P (B1_P).

The IEEE 1394 DSP 414 registers external device information by receiving data from other IEEE 1394 devices connected to the network via the switcher 412 and forms the network.

The CPU 416 generates the switching control signal to switch between the bypass mode and the input mode of the switcher 412 by receiving a switch off command from the CPU 422 of the data processing unit 420 (see FIG. 4), stores information on data input from the IEEE 1394 DSP 414, and performs necessary controls in response to the information from the CPU 422 and the IEEE 1394 DSP 414. Alternatively, the CPU 416 can change the switcher 412 to the input mode according to a normal network operation or a user's network connection selection.

The data processing unit 420 will now be described in more detail with reference to FIG. 4.

If the CPU 422 senses the power off state or an abnormal operation while receiving data from the IEEE 1394 DSP 414, the CPU 422 receives bus connection information by providing the bus reset command to the CPU 416 of the IEEE 1394 controller 410 and receives a message to confirm a switch off mode by transmitting the switch off command to bypass the IEEE 1394 bus signal to another IEEE 1394 device. Each of the above described communications can be performed between the CPU 422 and the CPU 416.

The audio DSP 424 decodes the data input to the CPU 422 to an audio signal. Thus, the audio signal decoded by the audio DSP 424 is reproduced to sound by passing through a Digital-to-Analog Converter (DAC: not illustrated) and an amplifier (not illustrated).

Referring back to FIG. 5, the 4 pair type signals A0_N (A1_N), A0_P (A1_P), B0_N (B1_N), and B0_P (B1_P) are input to terminals at one side of the switcher 412. In addition, input terminals of the IEEE 1394 DSP 414 are connected to terminals at the other side of the switcher 412. Thus, the terminals at one side and the other side of the switcher 412 are enabled or disabled in a software manner according to the switching control signal of the CPU 416, and the terminals operate in a hardware manner according to whether power is supplied thereto.

FIG. 6 is a circuit diagram of the IEEE 1394 controller 410 illustrated in FIG. 4, which allows network connection between the switcher 412 and the IEEE 1394 DSP 414 when an IEEE 1394 network system is turned on, according to an embodiment of the present general inventive concept.

Referring to FIG. 6, if the IEEE 1394 network system is turned on, the switcher 412 is changed to the input mode so that the terminals at one side and at the other side thereof are connected to each other. Thus, the 4 pair type signals A0_N (A1_N), A0_P (A1_P), B0_N (B1_N), and B0_P (B1_P) are input to the input terminals of the IEEE 1394 DSP 414. The IEEE 1394 DSP 414 registers external device information by communication with the CPU 416 and forms a network using the external device information.

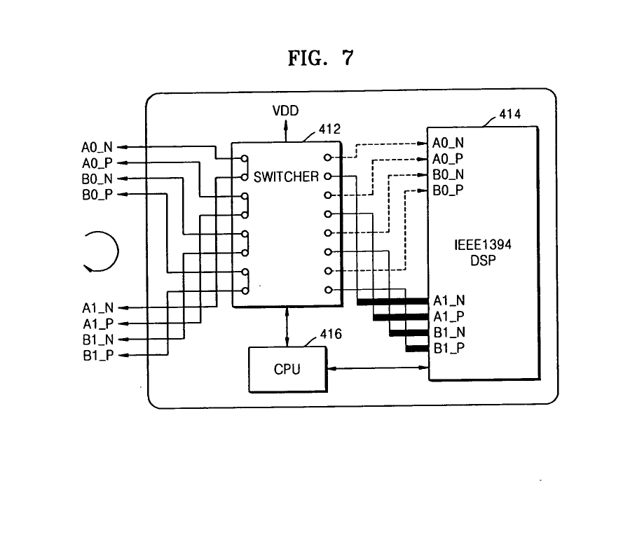

FIG. 7 is a circuit diagram of the IEEE 1394 controller 410 illustrated in FIG. 4, which does not allow network connection between the switcher 412 and the IEEE 1394 DSP 414 when the IEEE 1394 network system is turned off or abnormally operates, according to an embodiment of the present general inventive concept.

Referring to FIG. 7, if the IEEE 1394 network system is turned off or abnormally operates, the IEEE 1394 DSP 414 and the CPU 416 switch to the power off state in which the IEEE 1394 DSP 414 and the CPU 416 cannot operate since power the is charged in the system is also discharged after a predetermined time elapses. Thus, the switcher 412 changes to the bypass mode so that the terminals at one side and at the other side thereof become disconnected from each other. As a result, the 4 pair type signals A0_N (A1_N), A0_P (A1_P), B0_N (B1_N), and B0_P (B1_P) which are input to the switcher 412 are bypassed to another IEEE 1394 device without being input to the IEEE 1394 DSP 414.

That is, the switcher 412 bypasses the input IEEE 1394 bus signal to another IEEE 1394 device by connecting signal lines having the same function to each other according to a switch off signal.

Thus, the 4 pair type signals A0_N (A1_N), A0_P (A1_P), B0_N (B1_N), and B0_P (B1_P) input to the switcher 412 can be bypassed to another IEEE 1394 device without being input to the input terminals of the IEEE 1394 DSP 414.

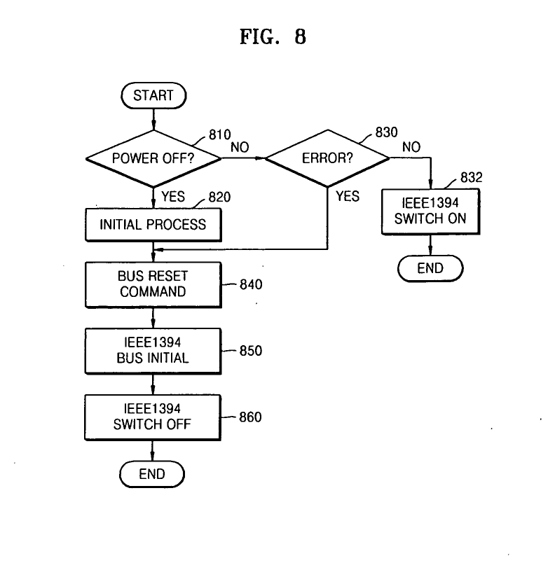

FIG. 8 is a flowchart illustrating a method of forming an IEEE 1394 AV network when an IEEE 1394 device is turned off or is in a malfunction state, according to an embodiment of the present general inventive concept.

Referring to FIG. 8, at operation 810, the data processing unit 420 of FIG. 4 compares a current voltage level to a reference voltage-level, and if the current voltage level is lower than the reference voltage level, the data processing unit 420 senses the power off state.

If the data processing unit 420 senses the power off state, the data processing unit 420 terminates operations of device blocks except the IEEE 1394 controller 410 of FIG. 4 by performing an initialization (e.g. “initial) process at operation 820.

If the data processing unit 420 does not sense the power off state, the data processing unit 420 determines at operation 830 whether the IEEE 1394 device is in a malfunction (error) state. For example, when the data processing unit 420 receives information which does not follow a predetermined specification, or when no response is input from the IEEE 1394 controller 410, the data processing unit 420 determines that the IEEE 1394 device is in the malfunction (error) state. Thus, if it is determined in operation 830 that the IEEE 1394 device is not in the malfunction (error) state, the data processing unit 420 generates a switch on signal corresponding to the input mode at operation 832.

If the initialization process is completed at operation 820, or if it is determined in operation 830 that the IEEE 1394 device is in the malfunction (error) state, the data processing unit 420 provides a bus reset command to the IEEE 1394 controller 410 at operation 840. Thus, IEEE 1394 devices connected to the network reload and update information regarding currently connected devices by performing a bus initialization process according to the bus reset command received via the IEEE 1394 controller 410 at operation 850.

In operation 860, the data processing unit 420 provides a switch off signal to the IEEE 1394 controller 410. Thus, the IEEE 1394 controller 410 controls the switcher 412 to be changed to the bypass mode so that no signal is input to the data processing unit 420.

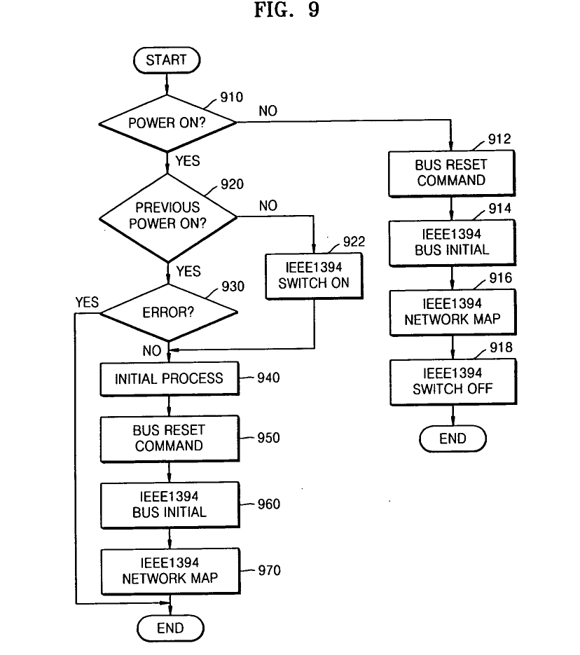

FIG. 9 is a flowchart illustrating a method of forming an IEEE 1394 AV network when a system is turned on, according to an embodiment of the present general inventive concept.

Referring to FIG. 9, at operation 910, the data processing unit 420 of FIG. 4 compares a current voltage level to the reference voltage level to sense the power on state.

If the data processing unit 420 does not sense the power on state at operation 910, the data processing unit 420 generates a bus reset command at operation 912, initializes an IEEE 1394 bus at operation 914, forms an IEEE 1394 network map by receiving information regarding devices connected to the IEEE 1394 AV network at operation 916, and provides a switch off signal to the IEEE 1394 controller 410 of FIG. 4 at operation 918.

If the data processing unit 420 senses the power on state at operation 910, the data processing unit 420 determines at operation 920, based on power information stored on a regular basis, whether a previous power state is the power on state.

If it is determined at operation 920 that the previous power state is not the power on state, the data processing unit 420 provides a switch on signal to the IEEE 1394 controller 410 in operation 922.

If it is determined at operation 920 that the previous power state is the power on state, the data processing unit 420 determines at operation 930 whether a device is in the malfunction (error) state.

If it is determined at operation 930 that the device is not in the malfunction (error) state, or if the switch on signal is generated in operation 922, the data processing unit 420 performs an initialization process at operation 940.

Thereafter, the data processing unit 420 generates the bus reset command at operation 950, initializes the IEEE 1394 bus at operation 960, and forms an IEEE 1394 network map by receiving information regarding devices connected to the IEEE 1394 AV network at operation 970.

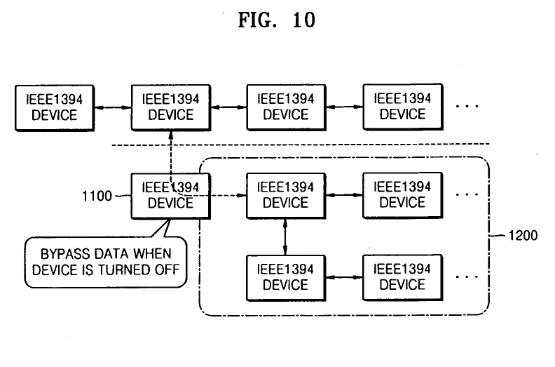

FIG. 10 is a conceptual diagram illustrating a connection configuration of an IEEE 1394 network when an intermediately connected device 1100 is turned off, according to an embodiment of the present general inventive concept.

Referring to FIG. 10, if a user turns off the intermediately connected device 1100, an IEEE 1394 bus signal input to the intermediately connected device 1100 is bypassed to another IEEE 1394 device. Thus, a new network is formed with IEEE 1394 devices 1200 remaining by excluding the device 1100 connected to the IEEE 1394 network, and thereby, the IEEE 1394 devices 1200 can normally operate in the IEEE 1394 network.

The general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the present general inventive concept, when an intermediate device abnormally operates from among devices connected to an IEEE 1394 network having a daisy chain or tree structure, a signal connection switch switches a signal connection state in IEEE 1394 input terminals. Thus, devices remaining by excluding the abnormally operating device connected to an IEEE 1394 network form a new network. The remaining devices normally operate in the IEEE 1394 network. In addition, by allowing a user to turn on/off a network using a network on/off selection menu, an off mode according to various conventional menu settings can be simply and correctly enabled.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of forming a network in a network system using a digital interface, the method comprising:
checking a power on/off state of a digital interface device in the network; and
if the power off state is sensed, transmitting a bus reset command to digital interface devices that form the network and bypassing a connected digital interface bus signal to another digital interface device.

2. The method of claim 1, further comprising:
if the power on state is sensed, transmitting the bus reset command to the digital interface devices that form the network and forming a network map by receiving a digital interface bus signal.

3. The method of claim 1, wherein the checking of the power on/off state comprises sensing the power on/off state by comparing a current voltage level to a reference voltage level.

4. The method of claim 1, wherein the digital interface is Institute of Electrical and Electronic Engineers (IEEE) 1394.

5. A method of forming a network in an Institute of Electrical and Electronic Engineers (IEEE) 1394 network system, the method comprising:
determining whether an IEEE 1394 device is in an error state; and
if it is determined that the IEEE 1394 device is in the error state, transmitting a bus reset command to IEEE 1394 devices that form the network and bypassing a connected bus signal to another IEEE 1394 device.

6. The method of claim 5, further comprising:
if it is determined that the IEEE 1394 device is not in the error state, transmitting the bus reset command to the IEEE 1394 devices that form the network and forming a network map by receiving a signal.

7. An Institute of Electrical and Electronic Engineers (IEEE) 1394 audio/video (AV) network system comprising:
an IEEE 1394 controller to accept an IEEE 1394 bus signal connected to IEEE 1394 devices or to bypass the IEEE 1394 bus signal to another IEEE 1394 device according to a power on/off state, and to control a connection with the IEEE 1394 devices; and
a data processing unit to transmit a bus reset command to the IEEE 1394 controller by sensing the power on/off state of a system, to simultaneously switch between a bypass mode and an input mode of the IEEE 1394 controller, and to decode a signal input from the IEEE 1394 controller.

8. The IEEE 1394 AV network system of claim 7, wherein the IEEE 1394 controller comprises:
an IEEE 1394 digital signal processor (DSP) to register external device information by receiving data from IEEE 1394 devices connected to the network, and to form a network;
a switcher to receive the IEEE 1394 bus signal connected to the network or to bypass the IEEE 1394 bus signal to another IEEE 1394 device according to a switching control signal to switch an input mode or a bypass mode; and
a controller to generate the switching control signal to switch the input mode or the bypass mode and to store and process information on data input from the IEEE 1394 DSP.

9. The IEEE 1394 AV network system of claim 7, wherein the data processing unit comprises:
a controller to receive data from the IEEE 1394 DSP, to generate the bus reset command of devices connected to the network by sensing the power off state, and to bypass the connected IEEE 1394 bus signal to another IEEE 1394 device; and
a DSP to decode the data received via the controller to an audio signal.

10. The IEEE 1394 AV network system of claim 7, further comprising a network on/off menu to control connection to the network to be on or off.

11. A digital interface device with a digital signal processor (DSP), comprising:
a CPU to sense a power off state of the digital interface device and to output a switch off command;
another CPU to communicate with the DSP and form a network between the digital interface device and another digital interface device in the power on state, and to receive the output switch off command and generate a switching control signal in the power off state; and
a switcher to connect signal lines to the DSP in the power on state, and to receive the switching control signal from the another CPU in the power off state, and redirect the signal lines from the DSP to another digital interface device.

12. The digital interface device of claim 11, further comprising:
a data processing unit to compare a current voltage with a reference voltage to determine whether the digital interface device is in a power off state or a power on state.

13. The digital interface device of claim 12, wherein the data processing unit further determines whether the digital interface device is in an error state if the digital interface device was in a power on state.

14. The digital interface device of claim 13, wherein:
the digital interface device disconnects from the second digital interface device when in an error state; and
the digital interface device connects to the second digital interface device when in a non-error state.

15. A method of controlling a digital interface device, comprising:
connecting signal lines to a digital signal processor (DSP) in a power on state;
disconnecting signal lines from the DSP in a power off state and redirecting the signal lines to another digital interface device; and
communicating with the DSP in the power on state to form a network between the digital interface device and the another digital interface device, wherein the digital interface device disconnects from the network in the power off state.

16. The method of claim 15, further comprising:
comparing a current voltage with a reference voltage to determine whether the digital interface device is in a power off state or a power on state.

17. The method of claim 16, further comprising:
determining whether the digital interface device is in an error state if the digital interface device was in a power on state.

18. The method of claim 17, further comprising:
disconnecting the digital interface device from the another digital interface device when in an error state; and
connecting the digital interface device to the another digital interface device when in a non-error state.

19. A switching system used with an IEEE 1394 AV network system, comprising:
a controller to select between a bypass mode to bypass an IEEE 1394 bus signal from one IEEE 1394 device to another IEEE 1394 or an input mode to input the IEEE bus signal to the one IEEE 1394 device; and
a data processor to sense a state of an IEEE 1394 device and to simultaneously provide a bypass or input mode switching control signal to the controller, and to decode a signal received from the controller.

20. The switching system of claim 19, wherein if the data processor senses a power off state or an abnormal state of an IEEE 1394 device, then the data processor receives bus connection information by providing a bus reset command to the controller and receives in response a message to confirm a switch off mode by transmitting the switch off command to bypass the IEEE 1394 bus signal to another IEEE 1394 device.
